(19) United States
(12) Patent Application Publication
(10) Pub. No.: US 2019/0026720 A1
(43) Pub. Date: Jan. 24, 2019

(54) ELECTRONIC RECEIPT MANAGEMENT SYSTEM INCLUDING SERVER THAT GENERATES UNIFIED EXPRESSIONS FOR PRODUCT NAMES ACROSS A PLURALITY OF STORES

(71) Applicant: TOSHIBA TEC KABUSHIKI KAISHA, Tokyo (JP)

(72) Inventor: Koichi SUGIYAMA, Izunokuni Shizuoka (JP)

(21) Appl. No.: 16/049,370

(22) Filed: Jul. 30, 2018

Related U.S. Application Data
(63) Continuation of application No. 14/733,338, filed on Jun. 8, 2015, now abandoned.

(30) Foreign Application Priority Data
Jun. 10, 2014 (JP) 2014119874

(51) Int. Cl. G06Q 20/20; G07G 5/00; G06Q 20/04

(52) U.S. Cl. CPC G06Q 20/209; G07G 5/00; G06Q 20/0453; G06Q 20/202

(57) ABSTRACT

An electronic receipt management system includes a point of sale terminal at a first location that generates electronic receipt information including a first product name that is specific to the first location for a first product. A first server receives the electronic receipt information from the point of sale terminal. A second server receives the electronic receipt information from the first server and generates a unified name for the first product that is the same for electronic receipt information received from a plurality of locations, converts the first product name in the received electronic receipt information to the unified name for the first product, generates converted electronic receipt information incorporating the unified name, and then transmits the converted electronic receipt information to a mobile computing device.

### FIELD

Embodiments described herein relate generally to an electronic receipt management server that generates unified expressions for product names.

### BACKGROUND

One type of an electronic receipt system transmits an electronic data of a purchase transaction at a store (i.e., an electronic receipt) to a computing device of a customer, such as a mobile device, instead of a conventional paper receipt that is handed to the customer upon completion of the purchase transaction.

The electronic receipt is useful to the customer, because the customer can manage his or her purchase transactions electronically. Further, the electronic receipt is useful to the store, because the store can reduce paper usage and with full conversion, will not need to invest in machines that issue the paper receipt. In addition, providing electronic receipts instead of paper receipts may reduce the time necessary to carry out settlement processing for the purchase transaction.

When a plurality of stores (retailers) participates in such an electronic receipt system, the retailers may use different merchandise names for the same merchandise for their own convenience. As a result, the customer may not recognize that two different merchandise names on electronic receipts correspond to the same product.

### DESCRIPTION OF THE DRAWINGS

FIG. 1 illustrates an entire configuration of an electronic receipt system according to a first embodiment.

FIG. 2 is a block diagram of a POS terminal in the electronic receipt system.

FIG. 3 is a block diagram of an electronic receipt server in the electronic receipt system.

FIG. 4 is a block diagram of an electronic receipt management server in the electronic receipt system.

FIG. 5 illustrates an example of a data configuration of a conversion master stored in the electronic receipt management server.

FIG. 6 is a block diagram of a mobile terminal in the electronic receipt system.

FIG. 7 is a functional block diagram of sections generated in the POS terminal.

FIG. 8 is a flowchart illustrating a flow of the electronic receipt processing carried out by the POS terminal.

FIG. 9 is a flowchart illustrating a flow of electronic receipt management processing and information transmission processing carried out by the electronic receipt server.

FIG. 10 is a functional block diagram of sections generated in the electronic receipt management server.

FIG. 11 is a flowchart illustrating a flow of the electronic receipt management processing and the information transmission processing carried out by the electronic receipt management server.

FIG. 12 is a functional block diagram of sections generated in the mobile terminal.

FIG. 13 is a flowchart illustrating a flow of the electronic receipt reception processing and the electronic receipt display processing carried out by the mobile terminal.

FIG. 14 illustrates an example of an electronic receipt displayed on a display unit of the mobile terminal.

FIG. 15 illustrates an example of a data configuration of a conversion master according to a second embodiment.

### DETAILED DESCRIPTION

Embodiments provide an electronic receipt management server that generates unified expressions for product names that are displayed on a mobile computing device as part of electronic receipt information.

In general, according to one embodiment, an electronic receipt management server is configured to generate unified expressions for product names that are displayed on a mobile computing device as part of electronic receipt information, and includes a network controller and a processor. The network controller receives first and second electronic receipt data, from a first store server and a second store server, respectively. The same product is identified by a first product name in the first electronic receipt data and by a second product name, different from the first product name, in the second electronic receipt data. The processor is configured to maintain a table having multiple mapping entries, each associating a unified product name to a plurality of different product names, to convert the first and second product names into an associated unified product name according to the table, and to transmit through the network controller, the first and second electronic receipt data, each containing the associated unified product name in place of the first and second product names, respectively, to a mobile computing device correlated to a user code specified in the corresponding first or second electronic receipt data.

### First Embodiment

Hereinafter, a first embodiment will be described with reference to the drawings.

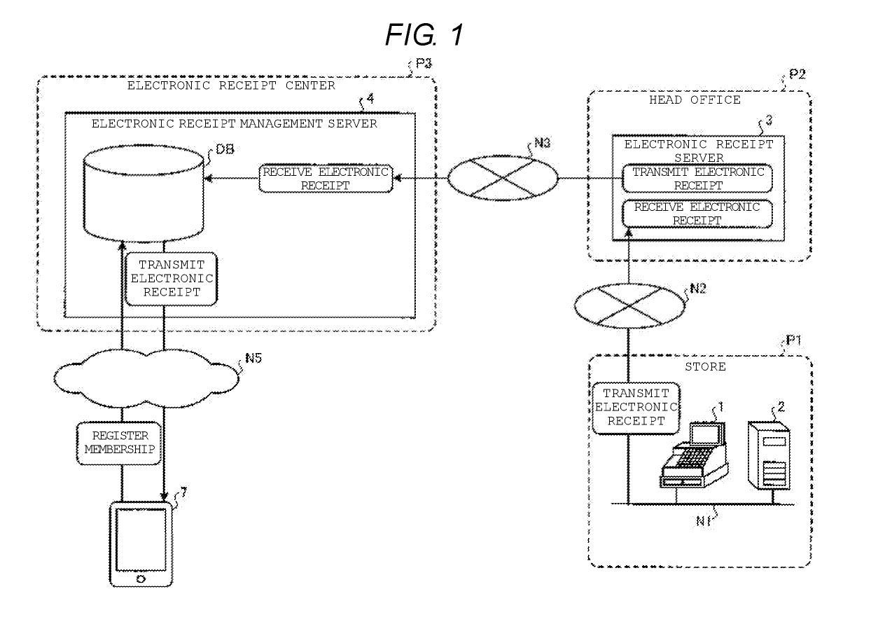

FIG. 1 illustrates the entire configuration of an electronic receipt system according to a first embodiment. As illustrated in FIG. 1, the electronic receipt system includes a Point of Sales (POS) terminal 1, a store server 2, an electronic receipt server 3, an electronic receipt management server 4, and a mobile terminal 7.

The POS terminal 1 and the store server 2 are located in a store P1. The POS terminal 1 and the store server 2 are connected to a network N1 such as a Local Area Network (LAN) in the store P1 to be communicable with each other. In addition, the POS terminal 1 and the store server 2 are configured to be connected to a network N2 that connects the store P1 and a head office P2 through a network equipment (not illustrated) such as a router which is connected to the network N1 in the store P1. Here, the network N2, for example, is a dedicated line such as the Internet or a Virtual Private Network (VPN).

The POS terminal 1 is a merchandise sales data processing device and performs merchandise sales data processing. The POS terminal 1 generates receipt data including a content of a purchase transaction, and outputs a paper receipt by printing the receipt data using a printer 13. In addition, the POS terminal 1 outputs (transmits) an electronic receipt in which a data format of the receipt data has been converted, to the electronic receipt server 3 through the network N2. A transmission method of an electronic receipt is not particularly limited, and a general-purpose protocol such as HTTP or HTTPS may be used. Furthermore, the number of POS terminals 1 in the store P1 is not particularly limited, and a plurality of POS terminals 1 may be disposed.

The store server 2 integrally manages the merchandise sales data processing performed by the POS terminal 1. For example, the store server 2 stores and manages merchandise sales data which is generated during the merchandise sales data processing by the POS terminal 1, or stores and manages a merchandise data file or the like which is used during the merchandise sales data processing.

Furthermore, the number of POS terminals 1 in the store P1 is not particularly limited, and a plurality of POS terminals 1 may be disposed. In addition, in the present embodiment, the POS terminal 1 outputs the electronic receipt, but the configuration is not limited thereto, and the data format of the receipt data generated by the POS terminal 1 may be converted by the store server 2 or a conversion device (not illustrated). In that case, the receipt data may be output to the electronic receipt server 3 as the electronic receipt.

The electronic receipt server 3 is located in the head office P2 of a company which operates one or more stores or chain stores (hereinafter, store), and functions as a receipt management server for the company. The electronic receipt server 3, for example, performs functions such as sales management, sales analysis, and stock management of the company.

A plurality of electronic receipt servers 3 may be disposed for a plurality of companies on one server per company basis. Each company may be a provider of merchandise or service, and operate a store such as a convenience store, a supermarket, a grocery store, a drugstore, an apparel store, a home electric appliance shop, a department store, a household goods store, and an eatery.

In addition, the electronic receipt server 3 receives the electronic receipt transmitted from the POS terminal 1 through the network N2. Then, the electronic receipt server 3 transmits the received electronic receipt to the electronic receipt management server 4 through a network N3, which connects the head office P2 and an electronic receipt center P3.

Here, the network N3, for example, is a dedicated line such as the Internet or VPN. In addition, a transmission method of an electronic receipt is not particularly limited, and a general-purpose protocol such as HTTP or HTTPS may be used.

The electronic receipt management server 4 is located in the electronic receipt center P3. The electronic receipt center P3 is, for example, a third-party organization other than the company managing the receipt data using the electronic receipt server 3. Alternatively, the third-party organization or the like may also manage the electronic receipt server 3.

The electronic receipt management server 4 functions as a receipt management server for customer and collectively manages the receipt data of multiple companies each of which operates one or more stores. The electronic receipt management server 4 stores membership data such as a name or a member code of each customer (member) who completed membership registration through a procedure or the like, and transmission destination information (for example, an email address) of the mobile terminal 7, which is a transmission destination of the electronic receipt in a membership master stored in database DB, and manages the data. Furthermore, a membership management server or the like which stores and manages the membership data may be prepared separately from the electronic receipt management server 4.

In addition, the electronic receipt management server receives the electronic receipt transmitted from the electronic receipt server 3 through the network N3, stores the electronic receipt in an electronic receipt management region 43a (described below) stored in the database DB, and manages the electronic receipt. More specifically, the electronic receipt includes an element such as a member code in addition to the transaction content (merchandise sales data) of the purchase transaction, and is managed in correlation with the membership data of the corresponding member.

In addition, when the electronic receipt is stored in the database DB, the electronic receipt management server 4 specifies the transmission destination (the mobile terminal 7) by reference to the transmission destination information correlated with the member code in the electronic receipt. Then, the electronic receipt management server 4 transmits the electronic receipt stored in the database DB to the transmission destination through a network N5. Furthermore, when additional information is correlated with the electronic receipt, the additional information is also transmitted to the transmission destination.

In addition, when an electronic receipt inquiry designating a member code is received from the mobile terminal 7, which is connected through the network N5, the electronic receipt management server 4 extracts an electronic receipt corresponding to the member code from the database DB, and transmits the electronic receipt to the mobile terminal 7. Furthermore, when the additional information is correlated with the electronic receipt, the additional information is also transmitted to the mobile terminal 7 which has requested the additional information.

The mobile terminal 7 is a terminal device such as a smart phone, a mobile phone, Personal Digital Assistant (PDA), or a tablet computer which is used by a user (the customer) of the electronic receipt system. The mobile terminal 7 has an application such as a Web browser for displaying various kinds of information which are uploaded on the network N5. Furthermore, a terminal device such as PC may be used instead of the mobile terminal 7.

The mobile terminal 7 accesses the electronic receipt management server 4 through the network N5, and performs the membership registration with respect to the electronic receipt system. Here, the network N5 is the Internet or various public networks.

The membership registration of the customer in the electronic receipt system, for example, is performed according to the following procedure. The customer transmits a blank mail to the electronic receipt management server 4 from the mobile terminal 7 through the network N5. The electronic receipt management server 4 transmits a Uniform Resource Locator (URL) of a webpage for the membership registration to the received email address. The customer accesses the webpage for the membership registration from the mobile terminal 7 using the URL, and the mobile terminal 7 displays an input screen to which information (a name, transmission destination information, and the like) necessary for the membership registration is input. After receiving the necessary information input by the customer, the electronic receipt management server 4 performs the membership registration with respect to the membership master. After that, the electronic receipt management server 4 delivers a membership registration completion mail including a member code (customer code) and a password to the mobile terminal 7. As a result, the membership registration is terminated.

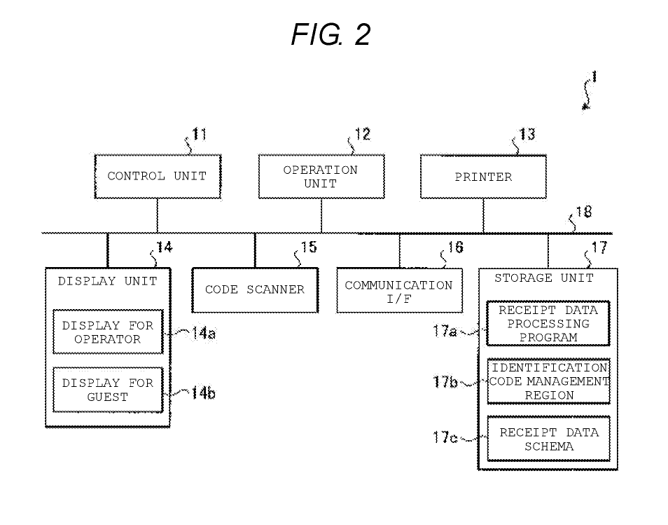

After the membership registration as described above, the mobile terminal 7 displays the member code of the customer on a display unit 73 (refer to FIG. 6) as a code symbol such as a bar code or a two-dimensional code. The customer exhibits the code symbol displayed on the mobile terminal 7 to a salesperson at the time of a purchase transaction in the store P1. The salesperson scans the code symbol displayed on the mobile terminal 7 using a code scanner 15 (refer to FIG. 2) connected to the POS terminal 1. As a result, the member code of the customer may be correlated with the receipt data generated after the merchandise sales data processing by the POS terminal 1.

In addition, after the purchase transaction at the POS terminal 1, the mobile terminal 7 receives the electronic receipt of the transaction from the electronic receipt management server 4 through the network N5. The electronic receipt of the member may be received from the electronic receipt management server 4, after the electronic receipt inquiry designating the member code has been transmitted to the electronic receipt management server 4 through the network N5. In addition, the mobile terminal 7 displays the received electronic receipt on the display unit 73.

In the electronic receipt system according to the above-described configuration, the electronic receipt (the receipt data) indicating the content of the purchase transaction (payment) generated through the merchandise sales data processing by the POS terminal 1 of the store P1 is transmitted to the electronic receipt management server 4 through the electronic receipt server 3, and is uploaded on the Web. Therefore, when the mobile terminal 7 having the Web browser designates the Uniform Resource Locator (URL), the receipt data uploaded on the Web may be downloaded to the mobile terminal 7 and displayed on the Web browser. Alternatively, a different application for displaying the receipt data on the mobile terminal 7 may be installed and displayed.

Next, the configuration of main devices configuring the electronic receipt system according to the present embodiment will be described.

First, the POS terminal 1, which is the merchandise sales data processing device, will be described. FIG. 2 is a block diagram of the POS terminal 1. As illustrated in FIG. 2, the POS terminal 1 includes a control unit 11 which integrally controls various calculations or each unit of the POS terminal 1. The control unit 11 includes a Central Processing Unit (CPU), a Read Only Memory (ROM) storing various programs or data items, a Random Access Memory (RAM) temporarily storing various programs or rewritably storing various data items, a Real Time Clock (RTC) unit that indicates current date and time, and the like.

The control unit 11 is connected to an operation unit 12, a printer 13, a display unit 14, and the code scanner 15, through a bus 18.

The operation unit 12 includes various operation keys with which the operator performs input operations. The operation keys include, for example, a register key for inputting a numerical value, a cursor key for selecting a predetermined item, a selection determination key, a subtotal key indicating a total price of the merchandise for which sales registration has been performed during the transaction, a settlement key settling the purchased merchandise in one transaction, and the like.

The printer 13 is a printer device printing the receipt, a journal, or the like. The printer 13 includes a cutting mechanism (not illustrated) that cuts paper such as rolled paper, which is a printing target, according to a cut command.

The display unit 14, for example, is a liquid crystal display or the like, and displays various kinds of information, such as the product name of the merchandise that has been subjected to the sales registration, the price, a total price of one transaction, and a change sum. The display unit 14 includes a display 14a for an operator, which displays various kinds of information to a cashier, and a display 14b for a guest, which displays various kinds of information to the customer. Furthermore, the display unit 14 may have a touch panel, and in this case, the touch panel functions as the operation unit 12.

The code scanner 15 is a scanner device optically reading the code symbol such as a bar code or a two-dimensional code. The code scanner 15, for example, reads a code symbol printed on the merchandise, a code symbol displayed on the mobile terminal 7, or the like, or outputs information contained in the code symbol to the control unit 11. Furthermore, in the code symbol printed on the merchandise, a merchandise code for specifying the merchandise or the like is included. In addition, in the code symbol displayed on the mobile terminal 7, a member code (customer code) for specifying the customer carrying the mobile terminal 7 or the like is included.

The control unit 11 is connected to a communication I/F (interface) 16 through the bus 18, and is configured to be connected to the network N1 or the network N2 in the store P1 through the communication I/F 16.

In addition, the control unit 11 is connected to the storage unit 17 through the bus 18. The storage unit 17 is, for example, an auxiliary storage device such as Hard Disk Drive (HDD) or Solid State Drive (SSD). The storage unit 17 stores a program for performing various POS operations including the merchandise sales data processing. In addition, the storage unit 17 stores various data files related to the merchandise sales data processing, such as a merchandise data file in which the merchandise data such as the merchandise name, the merchandise code, and the unit price of each product is stored. In addition, the storage unit 17 stores a receipt data processing program 17a for performing the merchandise sales data processing or processing related to the receipt data.

In addition, the storage unit 17 stores a POS number for identifying its own POS terminal 1, a company code (an identification code of the company which operates the store), a business type and business category code, a store code indicating the store P1 in which the POS terminal 1 is located, and the like in an identification code management region 17b. Here, the business type and business category code, for example, is a code (a sort code) specifying the business type and business category of the store, such as a convenience store, a supermarket, a department store, a pharmacy, a restaurant, an eatery, and the like. Furthermore, the business type and business category may be arbitrarily changed according to the preference of the user. In addition, the company code and the business type and business category code may also be registered in the electronic receipt server 3.

In addition, the storage unit 17 stores a receipt data schema 17c defining conversion rules used when receipt data in a non-structured format is converted into receipt data in a structured format such as XML or CSV (hereinafter, referred to as an electronic receipt). Specifically, in the receipt data schema 17c, a predetermined element configuring the receipt data and property information (a tag or the like) indicating properties of the element are defined.

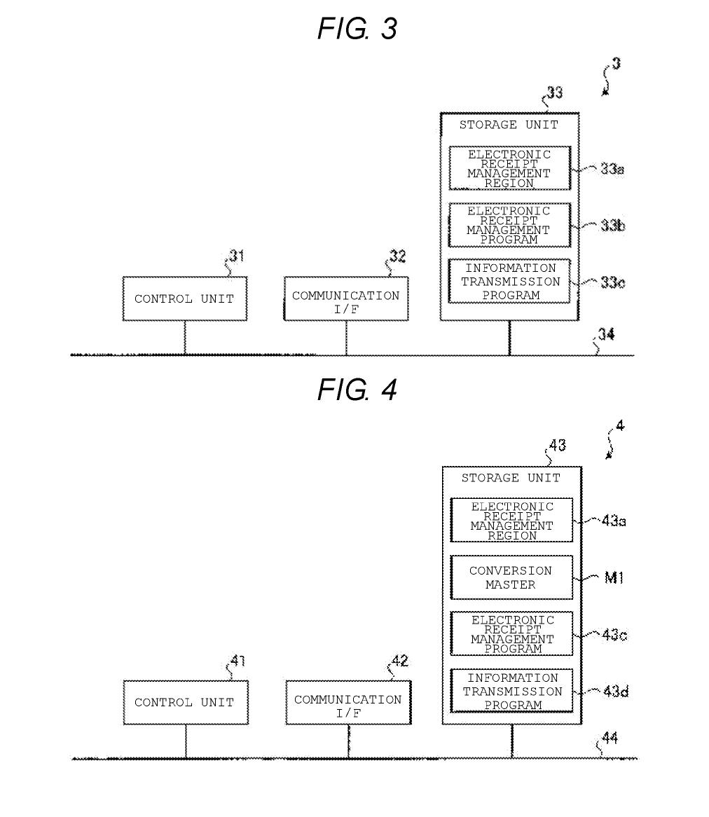

Next, the configuration of the electronic receipt server 3, which functions as a receipt management server for company, will be described with reference to a block diagram of FIG. 3. As illustrated in FIG. 3, the electronic receipt server 3 includes a control unit 31 which integrally controls various calculations or each unit of the electronic receipt server 3. The control unit 31 includes a CPU, a ROM storing various programs or data items, a RAM temporarily storing various programs or rewritably storing various data items, an RTC unit that indicates current date and time, and the like.

The control unit 31 is configured to be connected to the network N2 or the network N3 through the communication I/F 32 connected to a bus 34. In addition, the control unit 31 is connected to the storage unit 33 through the bus 34.

The storage unit 33 stores the electronic receipt of a company which operates one or more stores in an electronic receipt management region 33a. The electronic receipt includes the company code, the business type and business category code, the store code, the member code of the shopper, the POS number of the POS terminal 1, the receipt number, the merchandise sales data, and the like.

In addition, the storage unit 33 stores an electronic receipt management program 33b for managing the electronic receipt stored in the electronic receipt management region 33a. In addition, the storage unit 33 stores an information transmission program 33c for transmitting the receipt data managed in the electronic receipt management region 33a to the electronic receipt management server 4.

Next, the configuration of the electronic receipt management server 4, which functions as a receipt management server for customer, will be described with reference to a block diagram of FIG. 4. As illustrated in FIG. 4, the electronic receipt management server 4 includes a control unit (processor) 41 which integrally controls various calculations or each unit of the electronic receipt management server 4. The control unit 41 includes a CPU, a ROM storing various programs or data items, a RAM temporarily storing various programs or rewritably storing various data items, an RTC unit that indicates current date and time, and the like.

The control unit 41 is configured to be connected to the network N3, the network N4, and the network N5 through a communication I/F (network controller) 42 connected to a bus 44. In addition, the control unit 41 is connected to a storage unit 43 through the bus 44.

The storage unit 43 contains an electronic receipt management region 43a for collectively storing the electronic receipt of multiple companies each of which operates one or more stores, in addition to a membership master management region (not illustrated) for storing and managing the membership master. More specifically, the electronic receipt management region 43a is used to manage the electronic receipt of the multiple companies, with respect to each member.

The electronic receipt includes a member code, a company code (the identification code of the company which operates the store), a store code, a POS number of the POS terminal 1, a receipt number, merchandise sales data (including date and time data), and the like. A consumer goods manufacturer or the like may acquire certificate information of purchased merchandise associated with the manufacturer from the electronic receipt, in accordance with specific conditions (for example, a specific company which operates the store, a specific location, a specific time, and the like). Here, the consumer goods manufacturer is, for example, a manufacturer of food, drink, clothing, cosmetics, drug, house hold goods, and the like.

In addition, the storage unit 43 stores an electronic receipt management program 43c for managing the electronic receipt of each company stored in the electronic receipt management region 43a, in addition to a membership management program (not illustrated) for managing the membership master stored in a membership master region. In addition, the storage unit 43 stores an information transmission program 43d for transmitting the electronic receipt to the mobile terminal 7. Furthermore, the membership master management region and the electronic receipt management region 43a correspond to the database DB illustrated in FIG. 1.

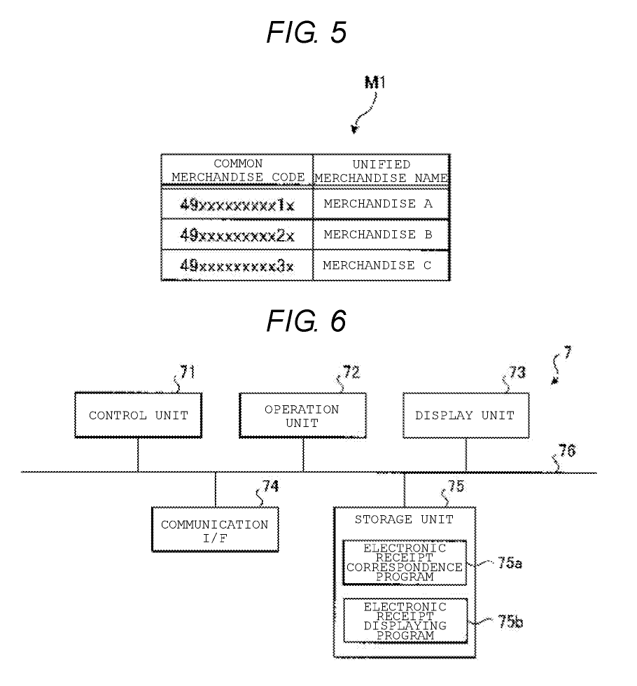

The storage unit 43 also stores a conversion master M1 of a common merchandise name, in which the merchandise code such as a JAN code or an EAN code is associated with a unified merchandise name (the merchandise name) commonly used in the companies. Here, FIG. 5 illustrates a data configuration of the conversion master M1. As illustrated in FIG. 5, the conversion master M1 stores the merchandise code (common merchandise code) such as the JAN code or the EAN code and the unified merchandise name by associating the merchandise code with the unified merchandise name.

As described above, the electronic receipt system according to the present embodiment can be utilized by a plurality of companies. That is, in the electronic receipt system according to the present embodiment, the POS terminal 1 or the store server 2 located in the store P1 of each company manages the merchandise name in the merchandise data file. Therefore, the merchandise name included in the electronic receipt, which is transmitted from the plurality of companies, may be different among the companies.

In such a case, even though the merchandise purchased by the consumer is the same kind of merchandise, the merchandise names registered in the merchandise data files of the companies may be different from each other, that is, the expression may be different among the companies, and thus the merchandise names displayed on the electronic receipt may not match each other between the companies.

For example, when the merchandise name is too long to print on a receipt, an abbreviated merchandise name unique to a store, half-sized characters (Japanese phonetic alphabet), or the like may be registered in the merchandise data file. Thus, when the same merchandise is respectively registered in the merchandise data file using the different merchandise names among the companies, and the consumer incorporates the electronic receipts including the different merchandise names for the same merchandise into an electronic household account book, the same merchandise may not be recognized as the same merchandise.

In addition, when data accumulated on the electronic receipt system is aggregated and provided to the third-party organization, or the right to aggregate is provided to the third-party organization, the same merchandise may not be recognized as such.

According to the present embodiment, the merchandise names different among the companies are converted into a unified merchandise name by using the conversion master M1 of the common merchandise name.

The electronic receipt management program 43c and the information transmission program 43d which are executed by the electronic receipt management server 4 according to the present embodiment are provided by being stored in a storage medium such as CD-ROM, flexible disk (FD), CD-R, or Digital Versatile Disk (DVD) which may be read by a computer in a file of an installable format or an executable format.

In addition, the electronic receipt management program 43c and the information transmission program 43d, which are executed by the electronic receipt management server 4 according to the present embodiment, may be stored on a computer connected to a network such as the Internet, and may be provided by being downloaded through the network. In addition, the electronic receipt management program 43c and the information transmission program 43d may be provided or distributed through the network such as the Internet.

In addition, the electronic receipt management program 43c and the information transmission program 43d according to the present embodiment may be provided by being incorporated in a ROM or the like in advance.

Next, the configuration of the mobile terminal 7 will be described with reference to a block diagram of FIG. 6. As illustrated in FIG. 6, the mobile terminal 7 includes a control unit 71 which integrally controls various calculations or each unit of the mobile terminal 7. The control unit 71 includes a CPU, a ROM storing various programs or data items, a RAM temporarily storing various programs or rewritably storing various data items, an RTC unit that indicates current date and time, and the like.

The control unit 71 is connected to an operation unit 72 and a display unit 73 through a bus 76. The operation unit includes various operation keys with which the user (customer) performs input operations, or a pointing device. The display unit 73 is, for example, a liquid crystal display or the like, and displays various kinds of information including the electronic receipt. Furthermore, the display unit 73 may have a touch panel, and in this case, the touch panel functions as the operation unit 72.

In addition, the control unit 71 is connected to a communication I/F 74 through the bus 76, and is connectable to the network N5 through the communication I/F 74. Furthermore, the control unit 71 is configured to be connected to the network N1 in the store P1 through the communication I/F 74.

In addition, the control unit 71 is connected to a storage unit 75 through the bus 76. The storage unit 75 stores an electronic receipt correspondence program 75a for receiving the electronic receipt from the electronic receipt management server 4, and an electronic receipt displaying program 75b for displaying the received receipt, in addition to the Web browser for displaying various kinds of information (content) uploaded on the Web.

Next, an operation of each unit configuring the electronic receipt system according to the present embodiment will be described.

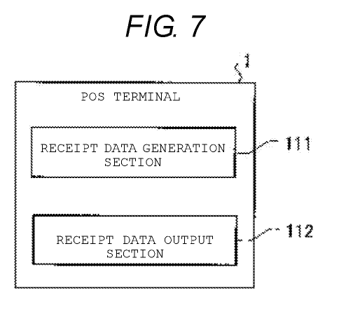

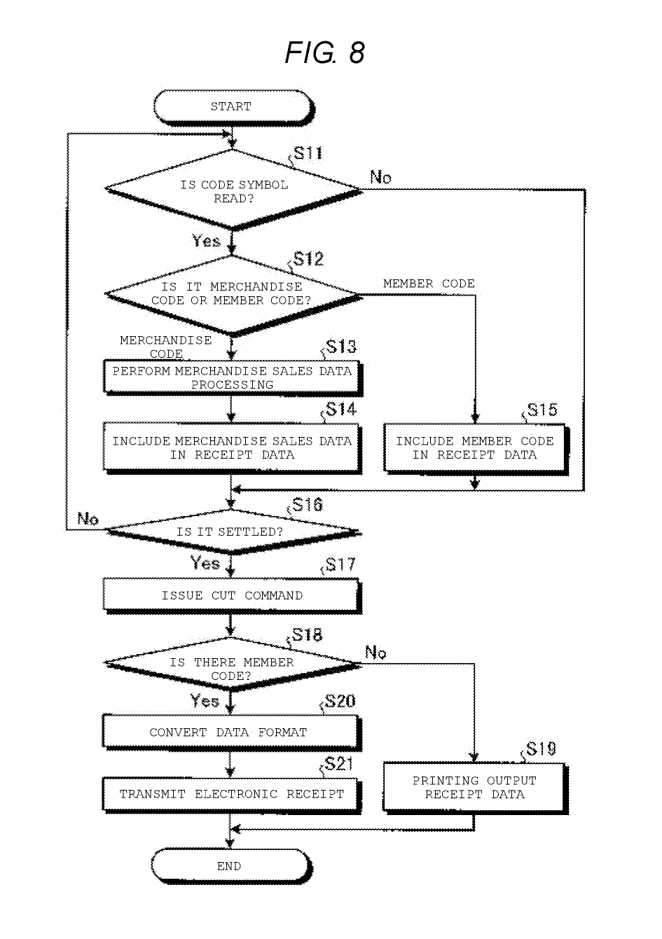

First, electronic receipt processing which is performed when the control unit 11 of the POS terminal 1 executes the receipt data processing program 17a will be described with reference to FIG. 7 and FIG. 8.

As illustrated in FIG. 7, when the receipt data processing program 17a is executed by the POS terminal 1, modules including a receipt data generation section 111, and a receipt data output section 112 are generated. As actual hardware, the CPU of the control unit 11 reads the receipt data processing program 17a from the storage unit 17 and executes the programs, and as a result each of the sections described above is loaded on the RAM, and the receipt data generation section 111 and the receipt data output section 112 are generated on the RAM.

Here, the receipt data generation section 111 is a functional unit corresponding to an existing application which mainly performs the merchandise sales data processing and generation of data (receipt data) for printing of the receipt. When the receipt data generation section 111 acquires merchandise code specifying the merchandise through the code scanner 15, the merchandise data corresponding to the merchandise code is read from the merchandise data file, and the merchandise sales data processing calculating the payment amount of money is performed based on the unit price included in the merchandise data. Then, the receipt data generation section 111 generates the merchandise sales data processed at the time of performing the merchandise sales data processing, that is, the receipt data including the content of the purchase transaction.

In addition, when the receipt data generation section 111 acquires the member code specifying the customer through the code scanner 15 at any timing in one transaction, the receipt data including the member code is generated.

In addition, when the settlement key is pressed, the receipt data generation section 111 determines that the merchandise sales data processing of one purchase transaction is completed, and outputs (issues) the generated receipt data to the receipt data output section 112 and a cut command. Here, the cut command is one of printer control commands which are generally used, and instructs cutting of the paper on which the receipt data is printed. Furthermore, the receipt data may be collectively generated by pressing the settlement key, or may be sequentially generated whenever the merchandise code or the customer code is acquired.

The receipt data output section 112 determines an output destination of the receipt data each time the receipt data of one purchase transaction is generated by the receipt data generation section 111. More specifically, when the cut command is issued by the receipt data generation section 111, the receipt data output section 112 determines that the receipt data of one purchase transaction is generated. Then, the receipt data output section 112 determines whether or not the member code is included in the generated receipt data, and outputs the receipt data to an output destination, which is determined based on a determination result thereof.

Specifically, when it is determined that the member code is not included in the receipt data, the receipt data output section 112 outputs the receipt data to the printer 13 along with the cut command. Accordingly, the receipt data is printed on the paper by the printer 13, and then the paper is cut according to the cut command. As a result, the paper receipt of one purchase transaction is printed out. Furthermore, at the time of the print out, all of the elements configuring the receipt data may be printed, or may be printed after removing the member code or the like or by adding the other information such as advertisement.

In addition, when it is determined that the member code is included in the receipt data, the receipt data output section 112 converts the format of the receipt data into a predetermined data format according to the conversion rules of the receipt data schema 17c. Then, the receipt data output section 112 transmits (outputs) the receipt data of which the data format has been converted, that is, the electronic receipt, to the electronic receipt server 3 which performs management of data associated with a certain company according to the company code.

The conversion from the receipt data to the electronic receipt is performed based on the conversion rules described in the receipt data schema 17c. Specifically, in the receipt data schema 17c, a predetermined element configuring the receipt data and property information (a tag or the like) indicating properties of the element are defined. The receipt data output section 112 structures each of the elements of the receipt data using corresponding property information, and then generates the electronic receipt in a structured format. By setting the electronic receipt to have a structured format, it is possible to efficiently use the element included in the electronic receipt, and obtain various advantages on the data management.

Thus, the receipt data output section 112 determines that the receipt data of one purchase transaction is generated based on the cut command issued by the receipt data generation section 111, and starts to output the receipt data. Accordingly, it is not necessary to use a dedicated signal for indicating the termination of one purchase transaction to the receipt data output section 112 from the receipt data generation section 111, and thus the receipt data generation section 111 corresponding to the existing application may not need to be particularly changed, and it is possible to output the receipt data of one transaction by the receipt data output section 112. In addition, it is possible to suppress a changed portion of the receipt data generation section 111, and thus it is possible to achieve an output function of the electronic receipt while efficiently diverting the existing application.

In addition, the receipt data output section 112 determines the output destination of the receipt data based on whether or not the member code is included in the receipt data. Accordingly, it is possible to output the paper receipt or the electronic receipt without generating unnecessary information of the paper receipt for each customer, and thus it is possible to efficiently determine the output destination of the receipt data. In addition, for example, the customer (the member) inputs or does not input the member code into each transaction, and thus it is possible to select the output of the paper receipt or the electronic receipt, and it is possible to improve convenience of the customer.

Further, when the receipt data is output to the electronic receipt server 3, the receipt data output section 112 converts the electronic receipt in which the element included in the receipt data is structured, and outputs the electronic receipt. As a result the element included in the electronic receipt can be used more conveniently by the electronic receipt server 3, the electronic receipt management server 4, or the mobile terminal 7 displaying the electronic receipt.

FIG. 8 is a flowchart illustrating a flow of the electronic receipt processing carried out by the POS terminal 1. First, the receipt data generation section 111 of the POS terminal 1 determines whether or not the code symbol (the merchandise code) applied to the merchandise or the code symbol (member code) displayed on the mobile terminal 7 is read by the code scanner 15 (Step S11). When it is determined that the code symbol is not read (Step S11; No), the process proceeds to Step S16.

In contrast, when it is determined that the code symbol is read (Step S11; Yes), the receipt data generation section 111 determines whether the information acquired is the merchandise code or the member code (Step S12).

In Step S12, if the merchandise code is acquired (Step S12; the merchandise code), when the receipt data generation section 111 reads the merchandise data from the merchandise data file with respect to the merchandise which is specified by the merchandise code, the calculation of the price is performed based on the unit price included in the merchandise data (Step S13). Subsequently, the receipt data generation section 111 generates the receipt data including the merchandise sales data which is processed at the time of performing the merchandise sales data processing (Step S14).

In addition, when the members code is acquired in Step S12 (Step S12; the member code), the receipt data generation section 111 includes the member code in the receipt data (Step S15).

Here, in order to input the member code into the POS terminal 1, for example, the customer (member) displays the code symbol including the member code or the like on the display unit 73 of the mobile terminal 7, and the salesperson or the customer scans the code symbol using the code scanner 15 of the POS terminal 1. Furthermore, the receipt data generation section 111 may perform processing, such that only one member code is associated with the transaction, even if more than two member codes are input.

Subsequently, in Step S16, the receipt data generation section 111 determines whether or not the start of the settlement processing is instructed by pressing the settlement key or the like (Step S16). When the start of the settlement processing is not instructed (Step S16; No), the process returns to Step S11. When the start of the settlement processing is instructed (Step S16; Yes), the receipt data generation section 111 issues (outputs) the cut command to the receipt data output section 112 (Step S17).

When the cut command is received from the receipt data generation section 111, the receipt data output section 112 determines that the receipt data of one transaction has been generated, and determines whether or not the member code is included in the receipt data (Step S18).

When the member code is not included in the receipt data (Step S18; No), the receipt data output section 112 outputs the receipt data of one transaction to the printer 13 along with the cut command, causing the receipt data to be printed out (Step S19), and terminates the processing. Accordingly, in the printer 13, the receipt data is printed on the paper, and then the paper is cut according to the cut command. As a result, the paper receipt of one transaction is printed out.

In contrast, when the member code is included in the receipt data (Step S18; Yes), the receipt data output section 112 generates the electronic receipt (electronic receipt information) by converting the data format of the receipt data, which is a non-structured format, into a structured format (Step S20). Then, the receipt data output section 112 transmits the generated electronic receipt to the electronic receipt server 3 through the communication I/F 16 (Step S21), and terminates the processing.

Furthermore, at the time of the conversion from the receipt data into the electronic receipt, data (for example, a common merchandise code such as a JAN code/an EAN code which corresponds to the merchandise) which is not included in the receipt data but exists in the processing may be added and then converted into the electronic receipt.

Furthermore, in the processing described above, when the member code is included in the receipt data, the receipt data is output to the electronic receipt server 3, but the configuration is not limited thereto, and the receipt data may be output to both of the printer 13 and the electronic receipt server 3.

In addition, when the member code is included in the receipt data, the output destination of the receipt data may be selected. For example, the mobile terminal 7 may include output classification information designating the output destination of the receipt data in the code symbol CS to be displayed, and select the output destination based on the output classification information. In this case, the receipt data generation section 111 includes the output classification information read by the code scanner 15 in the receipt data along with the member code. Then, the receipt data output section 112 determines whether or not the member code is included in the receipt data, and when it is determined that the output classification information exists, the output destination of the receipt data is determined based on the output classification information. Furthermore, any one or both of the printer 13 and the electronic receipt server 3 may be designated in the output classification information.

In addition, the output destination of the receipt data may be selected each time the payment for the purchase transaction is performed. In this case, for example, when it is determined that the member code is included in the receipt data, the receipt data output section 112 displays an output destination selection screen on the display unit 14 through which the customer selects the output destination of the receipt data.

Furthermore, the display of the selection screen is not limited to the display 14a for an operator, and the selection screen may be displayed on the display 14b for a guest. In addition, when the display 14b for a guest has a touch panel, the customer may select the output destination.

In addition, during the merchandise sales data processing, the customer may confirm the output destination of the receipt data. In this case, the receipt data generation section 111 displays the output destination selection screen G1 or the like on the display unit 14, and includes the selected output destination as the output classification information. Then, when the member code and the output classification information are included in the receipt data, the receipt data output section 112 determines the output destination of the receipt data based on the output classification information.

Thus, when the member code is included in the receipt data, the receipt data output section 112 may automatically select the output destination of the receipt data, or receive manual selection of the output destination. In such a manner, it is possible to easily switch a determination method of the output destination.

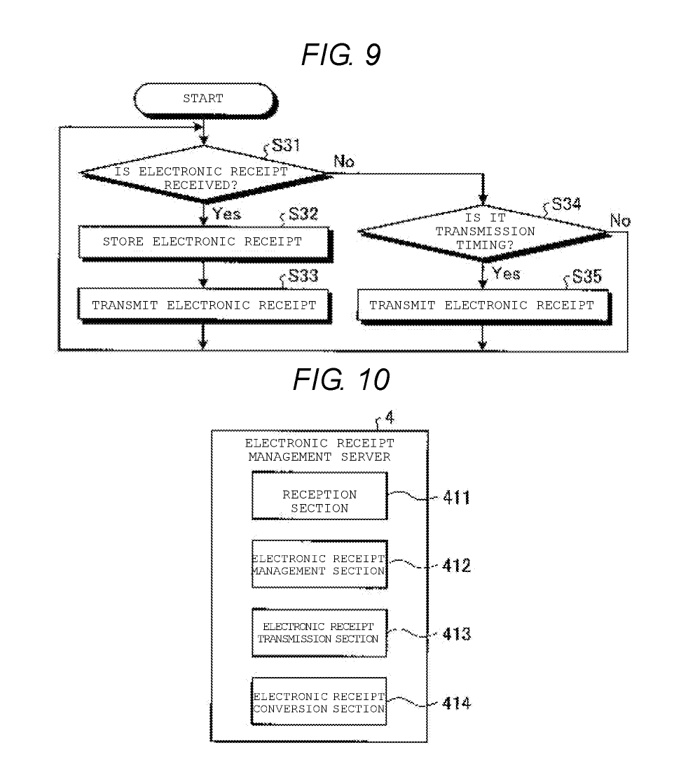

Next, a flow of the electronic receipt management processing which is performed when the control unit 31 of the electronic receipt server 3 executes the electronic receipt management program 33b and a flow of the information transmission processing which is performed when the control unit 31 of the electronic receipt server 3 executes the information transmission program 33c will be described with reference to a flowchart illustrated in FIG. 9.

When the electronic receipt, which is transmitted from the POS terminal 1, is received through the communication I/F (Step S31; Yes), the control unit 31 of the electronic receipt server 3 stores the electronic receipt in the electronic receipt management region 33a of the storage unit 33 with respect to each company (Step S32). Then, the control unit 31 of the electronic receipt server 3 transmits the electronic receipt stored in Step S32 to the electronic receipt management server 4 (Step S33), and returns to Step S31.

In addition, at a transmission timing which is set in advance (Step S31; No→Step S34; Yes), the control unit 31 of the electronic receipt server 3 transmits the electronic receipt which is stored in the electronic receipt management region 33a to the electronic receipt management server 4 (Step S35), and returns to Step S31. According to the transmission in Step S35, for example, the electronic receipt which is leaked from a transmission target in Step S33 may be transmitted to the electronic receipt management server 4. Furthermore, in Step S35, the transmission may be controlled such that only the electronic receipt which is not successfully transmitted is transmitted.

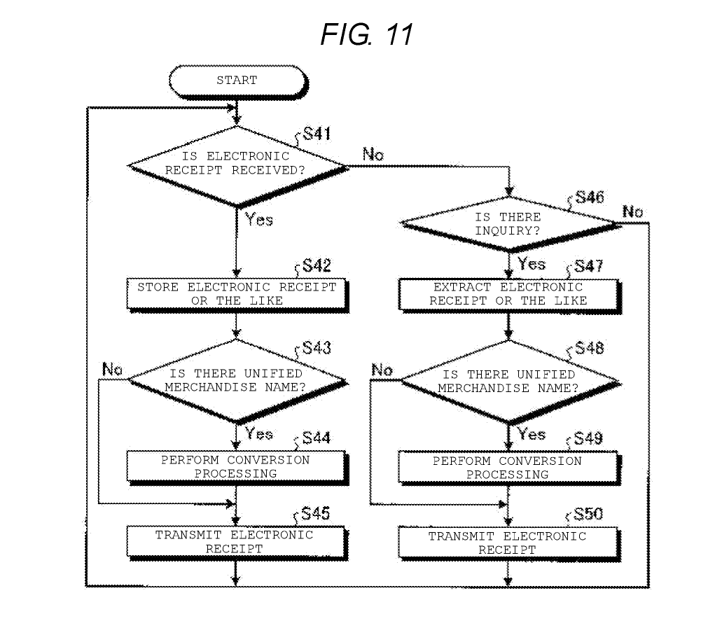

Next, a flow of the electronic receipt management processing which is performed when the control unit 41 of the electronic receipt management server 4 executes the electronic receipt management program 43c and a flow of the merchandise information transmission processing which is performed when the control unit 41 of the electronic receipt management server 4 executes the information transmission program 43d will be described with reference to a functional block diagram illustrated in FIG. 10 and a flowchart illustrated in FIG. 11.

As illustrated in FIG. 10, when the electronic receipt management program 43c and the information transmission program 43d are executed by the electronic receipt management server 4, modules including a reception section 411, an electronic receipt management section 412, an electronic receipt transmission section 413, and an electronic receipt conversion section 414 are generated. As actual hardware, the CPU of the control unit 41 reads the electronic receipt management program 43c and the information transmission program 43d from the storage unit 43 and executes the programs, and as a result each sections described above is loaded on the RAM, and the reception section 411, the electronic receipt management section 412, the electronic receipt transmission section 413, and the electronic receipt conversion section 414 are generated on the RAM.

The reception section 411 receives the electronic receipt which includes the company code of the company at which the transaction is carried out and is electronically processed instead of the paper receipt at the time of the merchandise sales data processing, from the electronic receipt server 3.

The electronic receipt management section 412 stores and manages the electronic receipt received by the reception section 411, with respect to each company, in the electronic receipt management region 43a of the storage unit 43.

The electronic receipt conversion section 414 acquires one or more electronic receipts including one or more company codes correlated with the member code of a predetermined shopper (consumer) from the electronic receipt management region 43a. After that, the electronic receipt conversion section 414 determines whether or not the merchandise code such as the JAN code or the EAN code which is included in the acquired electronic receipt is associated with the unified merchandise name in the conversion master M1. When it is determined that the merchandise code included in the acquired electronic receipt is associated with the unified merchandise name in the conversion master M1, the electronic receipt conversion section 414 converts the merchandise name of the acquired electronic receipt into the unified merchandise name.

The electronic receipt transmission section 413 transmits the electronic receipt in which the acquired electronic receipt or the merchandise name has been converted into the unified merchandise name.

As illustrated in FIG. 11, the reception section 411 of the electronic receipt management server 4 determines whether or not the electronic receipt transmitted from the electronic receipt server 3 of each of the companies has been received through the communication I/F 42 (Step S41).

When the electronic receipt has been received (Step S41; Yes), the electronic receipt management section 412 of the electronic receipt management server 4 stores the electronic receipt in the electronic receipt management region 43a of the storage unit 43 (Step S42). Subsequently, the electronic receipt conversion section 414 determines whether or not the merchandise code such as the JAN code or the EAN code which is included in the electronic receipt stored in Step S42 is associated with the unified merchandise name in the conversion master M1 (Step S43).

When it is determined that the merchandise code included in the acquired electronic receipt is associated with the unified merchandise name in the conversion master M1 (Step S43; Yes), the electronic receipt conversion section 414 converts the merchandise name of the acquired electronic receipt into the unified merchandise name (Step S44).

Subsequently, the electronic receipt transmission section 413 transmits the electronic receipt in which the acquired electronic receipt or the merchandise name has been converted into the unified merchandise name, to the transmission destination (mobile terminal 7) which is managed in correlation with the member code of the electronic receipt (Step S45), and returns to Step S41.

In addition, when there is an electronic receipt inquiry from the mobile terminal 7 (Step S41; No→Step S46; Yes), the electronic receipt conversion section 414 of the electronic receipt management server 4 extracts the electronic receipt which is stored in the electronic receipt management region 43a according to the content of the electronic receipt inquiry (Step S47), and determines whether or not the merchandise code such as the JAN code or the EAN code which is included in the electronic receipt is associated with the unified merchandise name in the conversion master M1 (Step S48).

When the merchandise code included in the acquired electronic receipt is associated with the unified merchandise name in the conversion master M1 (Step S48; Yes), the electronic receipt conversion section 414 converts the merchandise name of the acquired electronic receipt into the unified merchandise name (Step S49).

After that, the electronic receipt transmission section 413 transmits the electronic receipt in which the extracted electronic receipt or the merchandise name has been converted into the unified merchandise name, to the mobile terminal 7 from which the inquiry has been received (Step S50), and returns to Step S41.

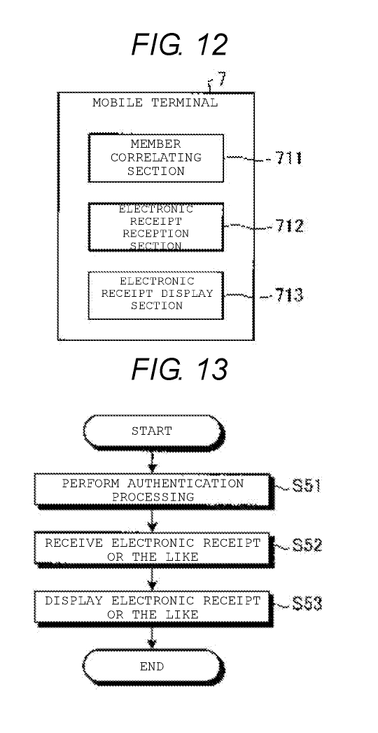

Next, a flow of the electronic receipt reception processing which is performed when the control unit 71 of the mobile terminal 7 executes the electronic receipt correspondence program 75a and a flow of the electronic receipt display processing which is performed when the control unit 71 of the mobile terminal 7 executes the electronic receipt displaying program 75b will be described with reference to FIG. 12 and FIG. 13.

As illustrated in FIG. 12, when the electronic receipt correspondence program 75a and the electronic receipt displaying program 75b are executed by the mobile terminal 7, modules including a member correlating section 711, an electronic receipt reception section 712, and an electronic receipt display section 713 are generated. As actual hardware, the CPU of the control unit 71 reads the electronic receipt correspondence program 75a and the electronic receipt displaying program 75b from the storage unit 75 and executes the programs, and as a result each of the sections described above is loaded on the RAM, and the member correlating section 711, the electronic receipt reception section 712, and the electronic receipt display section 713 are generated on the RAM.

The member correlating section 711 correlates the member code of the predetermined shopper. The electronic receipt reception section 712 receives the electronic receipt from the electronic receipt management server 4. The electronic receipt display section 713 displays the electronic receipt received by the electronic receipt reception section 712 on the display section 73.

As illustrated in FIG. 13, first, the member correlating section 711 of the mobile terminal 7 accesses the electronic receipt management server 4 and performs the authentication processing when the user inputs the member code and the password (Step S51). As a result, the mobile terminal 7 is correlated with a member code of a predetermined shopper.

After the authentication, the electronic receipt reception section 712 of the mobile terminal 7 receives the electronic receipt which is stored in the electronic receipt management region 43a of the electronic receipt management server 4 in response to the input member code (Step S52). In addition, when the additional information is correlated with the electronic receipt, the additional information is also received from the electronic receipt management server 4. Furthermore, the receipt data may be received by an email.

Next, the electronic receipt display section 713 of the mobile terminal 7 displays the electronic receipt received by the electronic receipt reception section 712 or the like on the display unit 73 (Step S53), and terminates the processing.

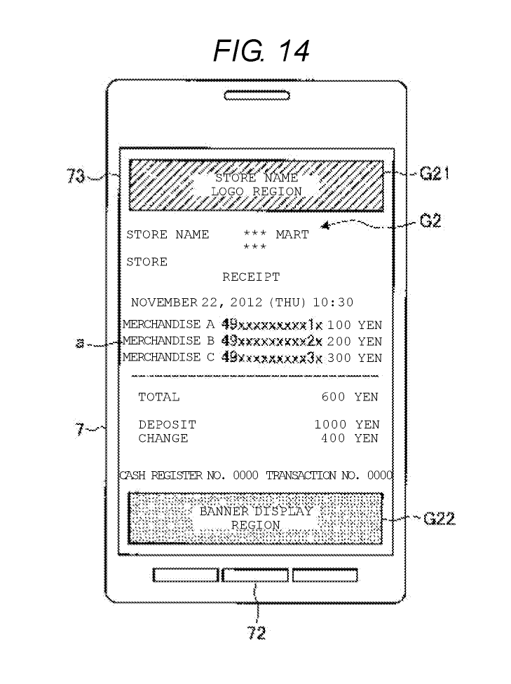

FIG. 14 illustrates an example of an electronic receipt G2 displayed on the display unit 73 of the mobile terminal 7. The electronic receipt G2 is displayed in the same layout or content as that of the receipt printed on the paper. In addition, on the display unit 73 displaying the electronic receipt G2, it is possible to select a purchased item according to a cursor following the input of the operation unit 72. In addition, in FIG. 14, a store name logo region G21 displaying a logo of a store name or a banner display region G22 displaying advertisement or the like is included in the electronic receipt G2.

In addition, according to the example illustrated in FIG. 14, when the merchandise name of the merchandise data file managed by the POS terminal 1 or the store server 2 in the store P1 of the company is the “merchandise a”, a unified merchandise name “merchandise A” is acquired from the conversion master M1 based on the merchandise code included in the electronic receipt, and the “merchandise a” is converted into the “merchandise A”.

Furthermore, it is not necessary that a display mode of the receipt data conforms to the image of the receipt printed on the paper. However, the receipt data is used instead of the paper receipt, and can be a proof of a purchase transaction. Therefore, to enable the electronic receipt to be used as the proof of the purchase transaction, as shown in FIG. 14, the following information is preferably displayed.
Store Name
Purchased Date and Time
Purchased Merchandise Specification
Total Price
Amount of Deposit
Amount of Change
Cash Register Number
Transaction Number

Furthermore, when a plurality of receipt data is received, a selection screen on which each of the receipt data items is selectable may be displayed based on a purchase date, the company code, and the like included in the receipt data. In this case, the electronic receipt display section 713 displays the receipt data selected from the selection screen on the display unit 73.

According to the electronic receipt management server 4 of the first embodiment, the data having different expressions (merchandise name) in the electronic receipt information for multiple companies are converted into the unified data (unified merchandise name), and thus it is possible to unify and handle the data having different expressions (merchandise name) among a plurality of companies in the electronic receipt system participated in by the plurality of companies.

Furthermore, in the present embodiment, the conversion master M1 storing the merchandise code (common merchandise code) in association with the unified merchandise name is stored in the storage unit 43 of the electronic receipt management server 4, which functions as the receipt management server for customer. In addition, the merchandise name which is uniquely used by each company is converted into the unified merchandise name by using the merchandise code (common merchandise code) included in the electronic receipt as a search key. However, the configuration is not limited thereto. For example, the conversion master M1 storing the merchandise code (common merchandise code) in association with the unified merchandise name may be stored in the storage unit 17 of the POS terminal 1, which is the merchandise sales data processing device. In addition, the receipt data generation unit 111 may convert the merchandise name which is uniquely used by each company into the unified merchandise name by using the merchandise code (the common merchandise code) included in the receipt as a search key.

Moreover, in addition to the unified merchandise name, other items (for example, a unified merchandise category which is common in all of the companies or the like) may be stored in the conversion master M1 in associated with the merchandise code (common merchandise code). As a result, it is possible to handle the merchandise categories different among a plurality of companies by converting the merchandise categories into the unified merchandise category on the electronic receipt system side participated in by the plurality of companies.

### Second Embodiment

Next, a second embodiment will be described with reference to the drawings. Here, the same reference numerals are applied to the same portions as those of the first embodiment described above, and the description thereof will be omitted.

In the first embodiment, the merchandise code (common merchandise code) is included in the electronic receipt, but in the second embodiment, the merchandise code (common merchandise code) is not included in the electronic receipt.

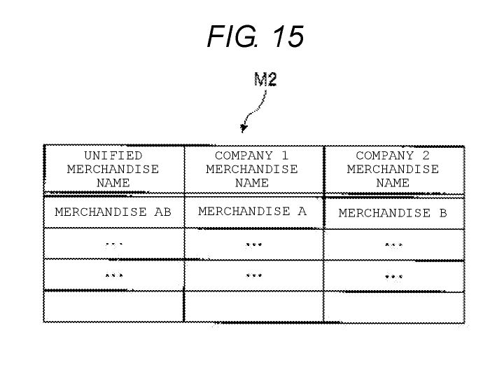

Here, FIG. 15 illustrates a data configuration of a conversion master M2 according to the second embodiment. As illustrated in FIG. 15, the conversion master M2 stores the unified merchandise name, and a unique merchandise name of the company, which is used in the merchandise data file stored in the POS terminal 1 or the store server 2 in the store P1 of the company, in association with each other.

Then, the electronic receipt conversion section 414 of the electronic receipt management server 4 determines whether or not the unique merchandise name of the company included in the acquired electronic receipt is associated with the unified merchandise name in the conversion master M2. When it is determined that the unique merchandise name of the company included in the acquired electronic receipt is associated with the unified merchandise name in the conversion master M2, the electronic receipt conversion section 414 converts the unique merchandise name of the company stored in the acquired electronic receipt into the unified merchandise name.

Thus, according to the electronic receipt management server 4 of the second embodiment, when the common merchandise code such as the JAN code/the EAN code, which is associated with the merchandise, is not included in the receipt data, the data having different expression for each company (the merchandise name) in the electronic receipt information for each of the companies is converted into the unified data (the unified merchandise name) having expression uniformly used by the companies, and thus it is possible to unify and handle the data having different expression for each company (the merchandise name) in the electronic receipt system cooperated with a plurality of companies.

Furthermore, in the present embodiment, the conversion master M2 storing the unique merchandise name of the company and the unified merchandise name, in association with each other, is stored in the storage unit 43 of the electronic receipt management server 4 which functions as the receipt management server for a customer, and the merchandise name which is uniquely registered in each of the companies is converted into the unified merchandise name by setting the unique merchandise name of the company included in the electronic receipt as a key in the electronic receipt management program 43c, but the configuration is not limited thereto. For example, the conversion master M2 may be stored in the storage unit 17 of the POS terminal 1 which is the merchandise sales data processing device, and the receipt data generation unit 111 may convert the merchandise name which is uniquely registered in each of the companies into the unified merchandise name by setting the unique merchandise name of the company included in the receipt as a key.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic receipt management system, comprising:
a point of sale terminal at a first location and generating electronic receipt information including a first product name that is specific to the first location for a first product;
a first server receiving the electronic receipt information from the point of sale terminal; and
a second server receiving the electronic receipt information from the first server and configured to generate a unified name for the first product that is the same for electronic receipt information received from a plurality of locations, convert the first product name in the received electronic receipt information to the unified name for the first product, generate converted electronic receipt information incorporating the unified name, and transmit the converted electronic receipt information to a mobile computing device.

2. The electronic receipt management system according to claim 1, wherein the second server comprises:
a network controller through which electronic receipt data is received from a first store server and a second store server; and
a processor configured to maintain a table having multiple mapping entries, each associating the unified product name to location specific product names for conversion to the unified product name according to the table.

3. The electronic receipt management system according to claim 2, wherein
each of the product name is associated with a store code in each of the mapping entries, and
the electronic receipt data includes a first store code.

4. The electronic receipt management system according to claim 1, wherein the product names is an abbreviated product name, and the unified product name is a non-abbreviated product name.

5. The electronic receipt management system, further comprising:
a mobile terminal configured to request converted electronic receipt information from the second server.
